(19) United States
(12) Patent Application Publication
(10) Pub. No.: US 2004/0224147 A1
(43) Pub. Date: Nov. 11, 2004

(54) Screen and manufacturing method thereof

(76) Inventor: Kuo Chung Chou, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/728,380

(22) Filed: Dec. 5, 2003

(30) Foreign Application Priority Data
Dec. 6, 2002 (TW) 091135768
Dec. 6, 2002 (TW) 091135767

(51) Int. Cl. B32B 27/00

(52) U.S. Cl. 428/331; 96/189; 428/500

(57) ABSTRACT

A self-cleaning screen mainly includes a mesh-like substrate containing titanium dioxide material with photocatalytic activity or a mesh-like substrate having a titanium dioxide coating with photocatalytic activity provided thereon. The present invention further provides a screen having nanoparticles provided on the mesh-like substrate thereof such that the surface of the screen has a low surface energy. The present invention further provides methods of manufacturing the aforementioned screens.

### BACKGROUND OF THE INVENTION

1. Field of the Invention

This invention relates to a screen.

2. Description of the Related Art

Screens are generally provided for doors and windows. Screens have a plurality of meshes which allow light and air to pass but exclude unwelcome things such as mosquitoes and other insects by adjusting the dimension of the meshes. However, after a screen was used for a period of time, dust and dirt are prone to accumulate around the meshes thereof. Therefore, the screen must be cleaned every other time. This is very troublesome.

### SUMMARY OF THE INVENTION

Therefore, it is an object of the present invention to provide a self-cleaning screen that promises to clean itself during use thereof while any additional cleaning procedure is unnecessary.

According to one embodiment of the present invention, there is provided a screen mainly comprising a mesh-like substrate and a titanium dioxide coating with photocatalytic activity provided on the mesh-like substrate thereby making the screen self-cleaning.

According to another embodiment of the present invention, there is provided another screen comprising a mesh-like substrate including a plurality of titanium dioxide particles with photocatalytic activity thereby making die screen self-cleaning.

The mesh-like substrate may be made of metal, ceramic materials or polymer materials. Polymer materials suitable for making the mesh-like substrate include nylon, poly vinyl chloride (PVC), polyethylene terephthalate (PET), polypropylene (PP) and so on.

The titanium dioxide coating may include titanium dioxide particles with an anatase crystal structure or a mixed crystal structure of anatase and rutile. Preferably, the titanium dioxide particles are nanosize (ranging between about 10 nm and about 100 nm). In the titanium dioxide particles containing a mixed crystal structure of anatase and rutile, the ratio of anatase to rutile is preferably 80:20.

The present invention further provides a method for manufacturing the self-cleaning screen. First, a plurality of polymer wires are weaved into a mesh-like substrate, and the mesh-like substrate is dipped into a resin bath thereby fixing the mesh-like substrate. Finally, a titanium dioxide coating with photocatalytic activity is formed on the mesh-like substrate by spray-coating, brush-coating or dipping. Alternatively, the titanium dioxide particles with photocatalytic activity may be directly added into the resin utilized in the fixing step or added into the mesh-like substrate such that the titanium dioxide coating step can be integrated into the fixing step or the mesh-like substrate forming step.

The illumination of TiO₂ with photocatalytic activity by light having a specific wavelength leads to an activation effect which results in the excitation of surrounding oxygen and water molecules into very active free radicals (.OH and .O2⁻) which are very powerful oxidants capable to decompose most organic materials and some inorganic materials. Since the screen provided by the present invention has a titanium dioxide coating with photocatalytic activity on the surface thereof, dust or dirt adhered to the screen can be decomposed by the titanium dioxide coating thereby achieving the goal of self-cleaning.

According to still another embodiment of the present invention, there is provided a screen comprising a mesh-like substrate and a plurality of nanoparticles on the surface of the mesh-like substrate. The nanoparticles are spreaded over the entire surface of the screen such that the screen has a super-hydrophobic surface (the water contact angle thereof larger than 115°).

The material of nanoparticles depends on the material of the mesh-like substrate. For example, when the mesh-like substrate is made of polyester material such as polyethylene terephthalate, the nanoparticles are preferably made of polyurethane (PU) material. When the mesh-like substrate is made of poly vinyl chloride (PVC), the nanoparticles are preferably made of nylon 6-clay composite. Nanoparticles made of other materials such as acrylic material, epoxy resin or ceramic material are also suitable for use in the present invention.

The present invention further provides a method for manufacturing the aforementioned screen. First, a plurality of polymer wires are weaved into a mesh-like substrate, and the mesh-like substrate is dipped into a resin bath thereby fixing the mesh-like substrate. Finally, a coating including suitable nanoparticles is formed on the mesh-like substrate by spray-coating, brush-coating or dipping. Alternatively, powders including the nanoparticles may be directly added into the resin utilized in the fixing step such that the nanoparticles coating step can be integrated into the fixing step. Alternatively, the nanoparticles may be provided on the surface of wires during the wire forming process, and then the wires with the nanoparticles thereon are further processed into a mesh-like substrate.

### DETAILED DESCRIPTION OF THE PREFERRED EMBODIMENTS

According to one embodiment of the present invention, there is provided a screen comprising a mesh-like substrate and a titanium dioxide coating with photocatalytic activity provided on the mesh-like substrate, wherein the titanium dioxide coating (a medium material for carrying out a catalytic effect via light) is capable of performing a photocatalytic reaction. Photocatalytic reaction, as being comprehended by its literal meaning, is a catalytic effect conducted via the energy provided by light, which results in the excitation of surrounding oxygen and water molecules into very active free radicals (.OH and .O2⁻) which are capable to decompose organic materials and inorganic materials which are pollutant or harmful to the environment.

Typically, the energy of a solar light having a wavelength in the rang of 300-800 nm is relatively high and is less likely affected by the greenhouse effect and the air pollution on the earth such that the solar energy can be used as a source to activate a photocatalyst.

A compound exhibiting semiconductor character and having a suitable energy difference (bandgap) of the valence band and the conductive band is considered as a photocatalytic material. Therefore, when an electron is promoted from the valence band to the conduction band under illumination of light, the resulting potential energy can be utilized to electrolyze water into hydrogen and oxygen. With regard to the titanium oxide of the present invention, the band gap energy of the titanium oxide is 3.2 eV which requires a solar energy occurring at a wavelength of about 380 nm. The reason why the titanium oxide is utilized as the photocatalytic material is that it has a high redox capacity and a high chemical stability, and it is nontoxic.

When the titanium oxide is illuminated by ultraviolet light having a wavelength less than 400 nm, the electrons in the valence band is promoted to the conduction band and a hole with a positive charge is generated in the valence band to form an electron-hole pair within a reaction time of only a few microseconds. The photocatalytic reaction occurred on the surface of the titanium oxide comprises the following steps:

1. Reactants, oxygen and water molecules are adhered to the surface of the titanium oxide.

2. Ultraviolet illumination of TiO₂ leads to the formation of electrons and holes.

3. The electrons and holes are captured and provided on the surface of the titanium oxide.

4. The electrons and holes react with oxygen and water to generate hydroxyl free radicals.

5. An oxidation reaction between the hydroxyl free radicals and the reactants occurs after step 4.

6. The product of step 5 leaves the surface of the titanium oxide.

According to another embodiment of the present invention, the titanium dioxide particles with photocatalytic activity are added in the mesh-like substrate of the screen.

The titanium dioxide material suitable for use in the present invention may include titanium dioxide particles with an anatase crystal structure or a mixed crystal structure of anatase and rutile. In the titanium dioxide particles containing a mixed crystal structure of anatase and rutile, the ratio of anatase to rutile is preferably 80:20. Preferably, the titanium dioxide particles are nanosize superfine particles such that the bandgap thereof is increased under the quantum dimension effect in order to enhance the reactivity of the electron-hole thereby significantly increasing the efficiency of the photocatalytic reaction.

The mesh-like substrate suitable for use in the present invention may be made of metal, ceramic materials or polymer materials. Polymer materials suitable for making the mesh-like substrate include nylon, poly vinyl chloride (PVC), polyethylene terephthalate (PET), polypropylene (PP), poly butylene terephthalate (PBT), and so forth.

The present invention further provides a method for manufacturing the aforementioned screen. First, polymer wires or metal wires are weaved into a mesh-like substrate. Alternatively, the mesh-like substrate may be made of ceramic materials. If the mesh-like substrate is obtained by a weaving step, it must be dipped into a resin bath for fixing. Finally, a titanium dioxide coating with photocatalytic activity is formed on the mesh-like substrate by spray-coating, brush-coating or dipping. Alternatively, the titanium dioxide particles with photocatalytic activity may be directly added into the resin utilized in the fixing step such that the titanium dioxide coating step can be integrated into the fixing step.

The present invention further provides another method to obtain a mesh-like substrate containing the titanium dioxide particles therein by directly adding the titanium dioxide material in the material for making the mesh-like substrate.

Since the mesh-like substrate of the screen is typically made of organic polymer material which may be decomposed by TiO₂, a buffer interface molecule may be added in the titanium dioxide coating such that one end of the buffer interface molecule is bonded to the titanium dioxide to form a micelle around the titanium dioxide and the other end of the buffer interface molecule is bonded to another ingredient of the titanium dioxide coating or the mesh-like substrate, thereby preventing TiO₂ from directly contacting the mesh-like substrate. Preferably, the buffer interface molecule contains at least one silicon atom for bonding with the titanium dioxide.

The screens provided by the present invention are suitable for use in screen windows, screen doors, reel type lace curtain, folding type lace curtain or automobile lace curtain. Since the surface coating of the screens has photocatalytic activity, most organic materials and some inorganic materials adhered to the surface of the screens can be decomposed. Therefore, the screens of the invention provide the functions of self-cleaning dust or dirt as well as decomposing ozone or bacterial in the air.

According to still another embodiment of the present invention, there is provided a screen comprising a mesh-like substrate and a plurality of nanoparticles on the surface of the mesh-like substrate. By the provision of the nanoparticles, the screen has a nanosize coarse surface which has a much higher hydrophobicity and a lower surface energy than a surface without nanoparticles and has a water contact angle larger than 115°. The super-hydrophobicity makes it very hard to have fluids such as water remained on the screen, and the low surface energy makes it very hard to have dust or dirt firmly attached on the screen. Therefore, it is very easy for fluids such as water to take away the dust or dirt adhered to the screen when the fluids flow through the screen thereby making the screen self-cleaning during normal rainy weather.

The mesh-like substrate suitable for use in the present invention may be made of metal, ceramic materials or polymer materials. Polymer materials suitable for making the mesh-like substrate include nylon, poly vinyl chloride (PVC), polypropylene (PP), poly butylene terephthalate (PBT), polyethylene terephthalate (PET), and so forth.

The material of nanoparticles depends on the material of the mesh-like substrate. For example, when the mesh-like substrate is made of polyester material such as polyethylene terephthalate, the nanoparticles are preferably made of polyurethane (PU) material. When the mesh-like substrate is made of poly vinyl chloride (PVC), the nanoparticles are preferably made of nylon 6-clay composite.

The nanoparticles can be provided on the surface of the screen in a variety of ways. One easier and cheaper way is to apply a coating containing nanoparticle powders to the surface of the screen.

The present invention provides several methods of forming nanoparticles on the surface of the screen.

First, polymer wires or metal wires are weaved into a mesh-like substrate. Alternatively, the mesh-like substrate may be made of ceramic materials or two different kinds of materials in accordance with different requirements. If the mesh-like substrate is obtained by a weaving step, it must be dipped into a resin bath for fixing. Finally, a coating including suitable nanoparticles is formed on the mesh-like substrate by brush-coating or spray-coating. Alternatively, powders including the nanoparticles may be directly added into the resin utilized in the fixing step such that the nanoparticles coating step can be integrated into the fixing step. Alternatively, the nanoparticles may be provided on the surface of wires during the wire forming process, and then the wires with the nanoparticles thereon are further processed into a mesh-like substrate.

According one embodiment of the present invention, the trick to produce a nylon 6-clay nanostructure is nanodispersion of the laminated clay which can be conducted by swelling the clay in a monomer solution and performing a one-pot polymerization reaction at low water content. The aforementioned method can be combined with the existing processes of producing the nylon 6-clay nanostructure in this industry.

Since the screen is typically made from a macromolecular substrate, it is relatively to fix nanoparticles of organic material on the macromolecular substrate. However, it is quite difficult to form nanoparticles of inorganic material or organic-inorganic composite on the macromolecular substrate. The nanoparticles of inorganic material or organic-inorganic composite can be fixed on the macromolecular substrate via the alkoxide sol-gel technique which involves the use of silane coupling agent, alkoxysilanes and inorganic nanoparticles sol to perform a film-plating process.

The screens provided by the present invention are suitable for use in screen windows, screen doors, reel type lace curtain, folding type lace curtain or automobile lace curtain. The surface coating of the screen has super-hydrophobicity and lower surface energy thereby making the screen self-cleaning via fluids in natural world.

The mesh-like substrate can be treated by corona discharge in advance thereby making it easier to fix the aforementioned nanoparticles on the mesh-like substrate.

Although the invention has been explained in relation to its preferred embodiment, it is to be understood that many other possible modifications and variations can be made without departing from the spirit and scope of the invention as hereinafter claimed.

What is claimed is:

1. A screen comprising:
a mesh-like substrate; and
a titanium dioxide coating with photocatalytic activity provided on the mesh-like substrate.

2. The screen as claimed in claim 1, wherein the titanium dioxide coating includes titanium dioxide particles with an anatase crystal structure or a mixed crystal structure of anatase and rutile.

3. The screen as claimed in claim 2, wherein the titanium dioxide particles contain a mixed crystal structure of anatase and rutile and the ratio of anatase to rutile is 80:20.

4. The screen as claimed in claim 2, wherein the titanium dioxide particles are nanosize.

5. The screen as claimed in claim 1, wherein the mesh-like substrate is formed from a polymer material selected from the group consisting of nylon, poly vinyl chloride (PVC), polyethylene terephthalate (PET), polypropylene (PP) and poly butylene terephthalate (PBT).

6. The screen as claimed in claim 1, wherein the titanium dioxide coating comprises a buffer interface molecule having one end bonded to the titanium dioxide and the other end bonded to another ingredient of the titanium dioxide coating or the mesh-like substrate.

7. The screen as claimed in claim 6, wherein the buffer interface molecule contains at least one silicon atom for bonding with the titanium dioxide.

8. A screen comprising a mesh-like substrate including a plurality of titanium dioxide particles with photocatalytic activity.

9. The screen as claimed in claim 8, wherein the titanium dioxide particles contain an anatase crystal structure or a mixed crystal structure of anatase and rutile.

10. The screen as claimed in claim 9, wherein the titanium dioxide particles contain a mixed crystal structure of anatase and rutile and the ratio of anatase to rutile is 80:20.

11. The screen as claimed in claim 8, wherein the titanium dioxide particles are nanosize.

12. The screen as claimed in claim 8, wherein the mesh-like substrate is formed from a polymer material selected from the group consisting of nylon, poly vinyl chloride (PVC), polyethylene terephthalate (PET), polypropylene (PP) and poly butylene terephthalate (PBT).

13. The screen as claimed in claim 8, further comprising a buffer interface molecule having one end bonded to the titanium dioxide and the other end bonded to the mesh-like substrate.

14. The screen as claimed in claim 13, wherein the buffer interface molecule contains at least one silicon atom for bonding with the titanium dioxide.

15. A screen comprising:
a polyester mesh-like substrate; and
a plurality of polyurethane nanoparticles provided on the surface of the polyester mesh-like substrate.

16. The screen as claimed in claim 15, wherein the mesh-like substrate is made of polyethylene terephthalate.

17. A screen comprising:
a poly vinyl chloride (PVC) mesh-like substrate; and
a plurality of nanoparticles made of nylon 6-clay composite provided on the surface of the PVC mesh-like substrate.

18. The screen as claimed in claim 17, wherein the mesh-like substrate is formed from poly vinyl chloride (PVC).
